(19) United States
(12) Patent Application Publication
(10) Pub. No.: US 2025/0178969 A1
(43) Pub. Date: Jun. 5, 2025

(54) VANADIUM CARBIDE WITH OXYGEN CONTENT OF 4,000 PPM OR LESS AND CARBON CONTENT OF BELOW 15 wt%

(71) Applicant: Korea Institute Of Geoscience And Mineral Resources, Daejeon (KR)

(72) Inventors: Ki-Min ROH, Daejeon (KR); Han-Jung KWON, Jeonju-si (KR); Sun-Kyung KIM, Daejeon (KR); Tae-Jun PARK, Daejeon (KR); Jae-Min SONG, Wanju-gun (KR); Do-Yeon LEE, Gwangju (KR)

(73) Assignee: Korea Institute Of Geoscience And Mineral Resources, Daejeon (KR)

(21) Appl. No.: 18/962,235

(22) Filed: Nov. 27, 2024

(30) Foreign Application Priority Data
Nov. 30, 2023 (KR) 10-2023-0170775

(51) Int. Cl. C04B 35/56; C04B 35/626

(52) U.S. Cl. CPC C04B 35/5607; C04B 35/62615; C04B 35/6265; C04B 2235/3817; C04B 2235/5436; C04B 2235/5454

(57) ABSTRACT

Provided is a vanadium carbide containing an oxygen content of 4,000 ppm or less and a carbon content of less than 15 wt %, where a crystalline system of the vanadium carbide exhibits a combination of a trigonal system and a cubic system, which facilitates the process for manufacturing MAX and MXene excluding the expensive vanadium metal.

### CROSS-REFERENCE TO RELATED APPLICATION

This application claims priority to Korean Patent Application No. 10-2023-0170775 filed on Nov. 30, 2023, and all the benefits accruing therefrom under 35 U.S.C. § 119, the contents of which is incorporated by reference in its entirety.

### BACKGROUND OF THE DISCLOSURE

### 1. Field of the Disclosure

The present disclosure relates to a vanadium carbide containing an oxygen content of 4,000 ppm or less and a carbon content of less than 15 wt %, where a crystalline system of the vanadium carbide exhibits a combination of a trigonal system and a cubic system. This vanadium carbide facilitates a process for manufacturing MAX and MXene excluding expensive vanadium metal.

### 2. Description of the Related Art

MXene, a two-dimensional carbide, which is composed of transition metals and carbons, is manufactured by selective etching of MAX, a ternary crystalline carbide.

The chemical formula of MAX is Mₙ₊₁AXₙ, and when the A layer is removed by selective etching, the two-dimensional MXene of Mₙ₊₁Xₙ is obtained. The transition metals corresponding to the M typically may be Ti, V, Cr, Mo, Nb, etc. The elements corresponding to the A may be Al and Si. The non-metallic elements C and N may be corresponding to the X.

Here, when hydrofluoric acid or hydrochloric acid is used to remove Al and Si at the position of the A in the MAX, the crystalline MAX is transformed into the two-dimensional MXene.

In general, crystalline MAX is synthesized through the reaction of the metals (M, A) with the non-metallic elements (X). However, there is a problem in that the transition metals are expensive.

Therefore, as a result of a long period of hard works and extensive researches, the applicant of the present disclosure has obtained a vanadium carbide containing an oxygen content of 4,000 ppm or less and a carbon content of less than 15 wt %, where a crystalline system of the vanadium carbide exhibits a combination of a trigonal system and a cubic system. This vanadium carbide facilitates the process for manufacturing MAX and MXene excluding the expensive vanadium metal.

### Related Patent Document

Korean Registered Patent No. 10-0430701 (Apr. 27, 2004)

### SUMMARY OF THE DISCLOSURE

Therefore, the purpose of the present disclosure is to provide a vanadium carbide containing an oxygen content of 4,000 ppm or less and a carbon content of less than 15 wt %, where a crystalline system of the vanadium carbide exhibits a combination of a trigonal system and a cubic system, which facilitates the process for manufacturing MAX and MXene excluding the expensive vanadium metal.

The challenges that the present disclosure is intended to solve are not limited to those mentioned above, and other challenges not mentioned will be apparent to those skilled in the art from the following description.

In order to achieve the purpose, an aspect of the present disclosure provides a vanadium carbide containing an oxygen content of 4,000 ppm or less and a carbon content of less than 15 wt %,
wherein the vanadium carbide is represented by chemical formula of V₂Cₓ and VC_{y},
wherein a range of the x is 0.5≤x≤0.75,
wherein a range of the y is 0.5≤y≤0.75, and
wherein a crystal system of the vanadium carbide exhibits a combination of a trigonal system (V₂Cₓ) and a cubic system (VC_{y}).

In some exemplary embodiments, the oxygen content of the vanadium carbide may be in a range of 10 ppm to 4,000 ppm.

In some exemplary embodiments, the carbon content of the vanadium carbide may be in a range from 10.5 wt % to less than 15 wt %.

In some exemplary embodiments, a particle size of the vanadium carbide may be in a range of 2 nm to 50 μm.

According to an exemplary embodiment of the present disclosure, there is provided a vanadium carbide containing an oxygen content of 4,000 ppm or less and a carbon content of less than 15 wt %, wherein a crystal system of the vanadium carbide exhibits a combination of a trigonal system and a cubic system, which facilitates the process for manufacturing MAX and MXene excluding the expensive vanadium metal. The vanadium carbide as raw material enables a low-cost MAX and MXene manufacturing process, and the manufactured MAX and MXene have low oxygen content and excellent electrical conductivity.

In addition, there is provided a method for manufacturing the vanadium carbide containing an oxygen content of 4,000 ppm or less and a carbon content of less than 15 wt %, wherein a crystal system of the vanadium carbide exhibits a combination of a trigonal system and a cubic system, which facilitates the process for manufacturing MAX and MXene excluding the expensive vanadium metal. The manufacturing method according to an exemplary embodiment of the present disclosure is economical because it has good process stability and enables mass production.

The effects of the present disclosure are not limited to the above effects, but are to be understood to include all effects that can be inferred from the detailed description of the present disclosure or from the composition of the elements as recited in the claims.

### BRIEF DESCRIPTION OF THE DRAWINGS

FIG. 1 is a process flow diagram of a method for manufacturing a vanadium carbide containing an oxygen content of 4,000 ppm or less and a carbon content of less than 15 wt % according to an exemplary embodiment of the present disclosure.

FIG. 2A is a graph illustrating the carbon content of the vanadium carbide containing an oxygen content of 4,000 ppm or less and a carbon content of less than 15 wt % according to an exemplary embodiment of the present disclosure.

FIG. 2B is a graph illustrating the oxygen content of the vanadium carbide containing an oxygen content of 4,000 ppm or less and a carbon content of less than 15 wt % according to an exemplary embodiment of the present disclosure.

FIG. 3 is a phase diagram of the vanadium carbide containing an oxygen content of 4,000 ppm or less and a carbon content of less than 15 wt % according to an exemplary embodiment of the present disclosure.

FIG. 4 is an XRD crystal structure graph of the vanadium carbide containing an oxygen content of 4,000 ppm or less and a carbon content of less than 15 wt % according to an exemplary embodiment of the present disclosure.

### DETAILED DESCRIPTION OF THE DISCLOSURE

Hereinafter, exemplary embodiments of the present disclosure will be described in detail with reference to related drawings.

The advantages and features of the present disclosure, and methods of accomplishing those advantages and features, will become apparent upon reference to the exemplary embodiments described in detail with reference to the accompanying drawings.

However, the present disclosure is not limited by the exemplary embodiments disclosed herein, but will be embodied in many and various forms. Therefore, those exemplary embodiments are provided merely to make the present disclosure complete and to give a complete picture of the scope of the present disclosure to one of ordinary skill in the art to which the present disclosure belongs, and the present disclosure shall be defined by the scope of the claims.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail.

Vanadium Carbide Containing an Oxygen Content of 4,000 ppm or Less and a Carbon Content of Less than 15 wt %

According to an exemplary embodiment of the present disclosure, there is provided a vanadium carbide containing an oxygen content of 4,000 ppm or less and a carbon content of less than 15 wt %, wherein a crystal system of the vanadium carbide exhibits a combination of a trigonal system and a cubic system, which facilitates the process for manufacturing MAX and MXene excluding the expensive vanadium metal.

In particular, according to an exemplary embodiment of the present disclosure, there is provided a vanadium carbide containing an oxygen content of 4,000 ppm or less and a carbon content of less than 15 wt %,
wherein the vanadium carbide is represented by chemical formula of V₂Cₓ and VC_{y},
wherein a range of the x is 0.5≤x≤0.75,
wherein a range of the y is 0.5≤y≤0.75, and
wherein a crystal system of the vanadium carbide exhibits a combination of a trigonal system (V₂Cₓ) and a cubic system (VC_{y}).

According to an exemplary embodiment of the present disclosure, there is provided a vanadium carbide containing an oxygen content of 4,000 ppm or less and a carbon content of less than 15 wt %, wherein a crystal system of the vanadium carbide exhibits a combination of a trigonal system and a cubic system, which facilitates the process for manufacturing MAX and MXene excluding the expensive vanadium metal. The vanadium carbide as raw material enables a low-cost MAX and MXene manufacturing process, and the manufactured MAX and MXene have low oxygen content and excellent electrical conductivity.

MXene, a two-dimensional carbide, which is composed of transition metals and carbons, is manufactured by selective etching of MAX, a ternary crystalline carbide.

The chemical formula of MAX is Mₙ₊₁AXₙ, and when the A layer is removed by selective etching, the two-dimensional MXene of Mₙ₊₁Xₙ is obtained. The transition metals corresponding to the M typically may be Ti, V, Cr, Mo, Nb, etc. The elements corresponding to the A may be Al and Si. The non-metallic elements C and N may be corresponding to the X. Here, when hydrofluoric acid or hydrochloric acid is used to remove Al and Si at the position of the A in the MAX, the crystalline MAX is transformed into the two-dimensional MXene.

In general, crystalline MAX is synthesized through the reaction of the metals (M, A) with the non-metallic elements (X). However, there is a problem in that the transition metals are expensive.

Therefore, as a result of a long period of hard works and extensive researches, the applicant of the present disclosure has obtained a vanadium carbide containing an oxygen content of 4,000 ppm or less and a carbon content of less than 15 wt %, where a crystalline system of the vanadium carbide exhibits a combination of a trigonal system and a cubic system. This vanadium carbide facilitates the process for manufacturing MAX and MXene excluding the expensive vanadium metal.

Here, the vanadium carbide according to an exemplary embodiment of the present disclosure may be a vanadium carbide containing an oxygen content of 4,000 ppm or less and a carbon content of less than 15 wt %, where a crystalline system of the vanadium carbide exhibits a combination of a trigonal system and a cubic system, which facilitates the process for manufacturing MAX and MXene excluding the expensive vanadium metal.

That is, the crystal system of the vanadium carbide containing an oxygen content of 4,000 ppm or less and a carbon content of less than 15 wt % may exhibit a combination of a trigonal system (V₂Cₓ) and a cubic system (VC_{y}).

Here, the trigonal crystal system (V₂Cₓ; R-3m) is a rhombohedral crystal system, in which all three vectors have the same length and all of the angles formed by each axis are not rectangular, forming a cube diagonally pulled apart.

In addition, the cubic system (VC_{y}; Fm-3m) is a cubic crystal system in which the unit cell is cubic in shape and the three crystal axes are perpendicular to each other.

In addition, the oxygen content of the vanadium carbide containing an oxygen content of 4,000 ppm or less and a carbon content of less than 15 wt % may be in a range of 10 ppm to 4,000 ppm.

Here, when the oxygen content is within the range of 10 ppm to 4,000 ppm, the oxycarbide in the form of V (CₓO₁₋ₓ) containing rich amount of oxygen may not be readily formed.

In addition, when the oxygen content exceeds 4000 ppm, alumina that is an oxide may be formed during the synthesis process of MAX, and there is a problem in that VC may be formed due to the lack of aluminum, resulting in a lowered MAX phase fraction.

Here, the oxygen content may preferably be from 30 ppm to 4,000 ppm. More preferably, the oxygen content may be from 100 ppm to 4,000 ppm.

In addition, the vanadium carbide containing an oxygen content of 4,000 ppm or less and a carbon content of less than 15 wt % may be represented by chemical formula of V₂Cₓ and VC_{y},
wherein a range of the x is 0.5≤x≤0.75, and
wherein a range of the y is 0.5≤y≤0.75.

Here, when the x is within the above range and the y is within the above range, the vanadium carbide containing an oxygen content of 4,000 ppm or less and a carbon content of less than 15 wt % may not readily form the oxycarbide in the form of V (CₓO₁₋ₓ) containing rich amount of oxygen.

In particular, in order to lower the cost of MAX synthesis, the transition metal carbides can be used, instead of the transition metals.

In addition, in respect to vanadium-based MAX, the reaction equation is as follows.

$$2 {VC}_{0.5} + Al \to {V}_{2} Al C \qquad ( Reaction Equation 1 )$$

$$4 {VC}_{0.75} + Al \to {V}_{4} Al {C}_{3} \qquad ( Reaction Equation 2 )$$

$$12 {VC}_{0.67} + 3 Al \to {V}_{12} {Al}_{3} {C}_{8} \qquad ( Reaction Equation 3 )$$

In addition, in the vanadium carbide containing an oxygen content of 4,000 ppm or less and a carbon content of less than 15 wt %, the carbon content may be in a range from 10.5 wt % to less than 15 wt %.

Here, there is a problem that, when the carbon content in the vanadium carbide containing an oxygen content of 4,000 ppm or less and a carbon content of less than 15 wt % is less than 10.5 wt %, it is required to add carbon during the MAX synthesis process.

In addition, when the carbon content in the vanadium carbide exceeds 15 wt %, it is required to add vanadium metal during the MAX synthesis process.

In addition, a particle size of the vanadium carbide containing an oxygen content of 4,000 ppm or less and a carbon content of less than 15 wt % may be in a range of 2 nm to 50 μm.

Here, the particle size of the vanadium carbide containing an oxygen content of 4,000 ppm or less and a carbon content of less than 15 wt % may preferably be from 100 nm to 50 μm. More preferably, the particle size of the vanadium carbide may be from 500 nm to 50 μm.

Method for Manufacturing Vanadium Carbide Containing an Oxygen Content of 4,000 Ppm or Less and a Carbon Content of Less than 15 wt %

According to an exemplary embodiment of the present disclosure, there is provided a method for manufacturing a vanadium carbide containing an oxygen content of 4,000 ppm or less and a carbon content of less than 15 wt %, wherein a crystal system of the vanadium carbide exhibits a combination of a trigonal system and a cubic system, which facilitates the process for manufacturing MAX and MXene excluding the expensive vanadium metal.

According to an exemplary embodiment of the present disclosure, the method for manufacturing the vanadium carbide containing an oxygen content of 4,000 ppm or less and a carbon content of less than 15 wt % may comprise:
(a-1) manufacturing a mixed powder by mixing vanadium oxide with carbon compound;
(a-2) introducing the mixed powder together with steel balls into a rotating vessel within a high-energy milling device;
(a-3) manufacturing a fine powder by high-energy milling in an atmosphere of atmosphere, vacuum, nitrogen, or argon, by applying a high energy of 0.6 to 2.4 J/g·s, and by rotating the rotating vessel and a rotating shaft in different directions to each other; and
(a-4) manufacturing a vanadium carbide containing an oxygen content of 4,000 ppm or less and a carbon content of less than 15 wt % by carbothermic reduction reaction by vacuum heat treatment of the fine powder.

There is provided a method for manufacturing the vanadium carbide containing an oxygen content of 4,000 ppm or less and a carbon content of less than 15 wt %, wherein a crystal system of the vanadium carbide exhibits a combination of a trigonal system and a cubic system, which facilitates the process for manufacturing MAX and MXene excluding the expensive vanadium metal. The manufacturing method according to an exemplary embodiment of the present disclosure is economical because it has good process stability and enables mass production.

Further, in the step (a-1) of manufacturing a mixed powder by mixing vanadium oxide with carbon compound, the mixing ratio of the vanadium oxide and the carbon compound may be from 1:0.2 to 1:0.7 by weight ratio.

Here, when the mixing ratio of the vanadium oxide and the carbon compound is within the above range by weight ratio, the oxycarbide in the form of V (CₓO₁₋ₓ) containing rich amount of oxygen may not be readily formed.

Here, the mixing ratio of the vanadium oxide and the carbon compound may preferably be from 1:0.4 to 1:0.6 by weight ratio. More preferably, the mixing ratio of the vanadium oxide and the carbon compound may be from 1:0.45 to 1:0.55 by weight ratio.

Further, the vanadium oxide may be at least one selected from the group consisting of vanadium pentoxide (V₂O₅), sodium metavanadate (NaVO₃), vanadium trioxide (V₂VO₃), vanadium oxychloride (VOCl₃), and ammonium metavanadate (H₄NVO₃).

Here, when the vanadium pentoxide (V₂O₅) is used as a raw material for the synthesis of vanadium carbide, the vanadium carbide may be formed through the reaction of vanadium oxide with carbon (i.e., carbothermic reduction reaction), as shown in the following Reaction Equation 4.

$${V}_{2} {O}_{5} + 7 C \to 2 VC + 5 CO \qquad ( Reaction Equation 4 )$$

In this process, theoretically, the vanadium carbide containing an oxygen content of 4,000 ppm or less and a carbon content of less than 15 wt % in the form of VCx may be synthesized, by adjusting the amount of carbon to less than 7 moles per mole of vanadium oxide.

However, in the actual process, when the amount of carbon acting as a reducing agent is lowered, the reaction rate in response to the reduction is also lowered such that the oxycarbide in the form of V (CₓO₁₋ₓ) containing rich amount of oxygen may be readily formed.

Furthermore, in order to form the vanadium carbides, it is required the treatment to increase the rate in response to the carbothermic reduction reaction, as well as the adjustment of carbon amount.

According to an exemplary embodiment of the present disclosure, the particle size of the mixed powder of vanadium oxide and carbon compound as the raw material was reduced to the aforementioned range through the high-energy milling process to increase the reaction rate. Thereby, the vanadium carbide containing an oxygen content of 4,000 ppm or less and a carbon content of less than 15 wt % can be synthesized.

Furthermore, the carbon compounds may be at least one selected from the group consisting of: industrial carbon powder, coke, coal, coal tar, activated carbon, graphite, natural graphite, artificial graphite, synthetic graphite, carbon black, acetylene black, ketchen black, channel black, furnace black, lamp black, summer black, thermal black, industrial diamond, and carbon fiber.

Here, the carbon compound may further comprise biomass that is at least one selected from the group consisting of coffee wastes, fallen leaves, and waste wood.

Further, the carbon compound may further comprise a reducing gas containing carbon that is at least one selected from the group consisting of carbon monoxide, methane, and hydrocarbons.

In addition, the high-energy milling may comprise the following steps of:
mixing the vanadium oxide and the carbon compound; and
introducing the mixed power of the vanadium oxide and the carbon compound with steel balls into a rotating vessel within the high-energy milling device;
wherein, in an atmosphere of atmosphere, vacuum, nitrogen or argon, a high energy of 0.6 to 2.4 J/g·s may be applied,
wherein the rotating shaft may be rotated at 150 to 300 rpm,
wherein the rotating vessel may be rotated at 300 to 600 rpm in a direction opposite to the direction of rotation of the rotating shaft, and
wherein the high-energy milling may be performed for 1 to 20 hours.

Further, in the step (a-2) of introducing the mixed powder together with steel balls into a rotating vessel within a high-energy milling device, the high-energy milling device may be a planetary ball mill, a SPEX mill, or an attritor.

Here, the planetary ball mill may reduce the particle size of the mixed powder of the vanadium oxide and the carbon compound within the aforementioned range, whereby the vessel of the planetary ball mill performs high-speed rotational and orbital movements after the steel balls are loaded into the vessel with the raw material.

Furthermore, the SPEX mill may reduce the particle size of the mixed powder of the vanadium oxide and the carbon compound within the aforementioned range, whereby the vessel of the SPEX mill performs high-speed vertical and horizontal vibrational movements after the steel balls are loaded into the vessel with the raw material.

In addition, the attritor may reduce the particle size of the mixed powder of the vanadium oxide and the carbon compound within the aforementioned range, whereby the energy is transmitted by rotational force of the rotor after the steel balls are loaded into the vessel with the raw material.

Furthermore, the high-energy milling device may the particle size of the mixed powder of the vanadium oxide and the carbon compound within the aforementioned range, by by rotating the rotating vessel containing the mixed powder of the vanadium oxide and the carbon compound in the direction opposite to the direction of rotation of the rotating shaft of the rotating plate.

In addition, in the step (a-2) of introducing the mixed powder together with steel balls into a rotating vessel within a high-energy milling device, the steel balls may be at least one selected from the group consisting of ceramic balls, metal balls, and cemented carbide balls.

In particular, the material of the steel ball may be steel, tungsten, or zirconia.

Here, the shape of the steel ball may be at least one selected from the group consisting of a spherical shape, a star shape, a horn shape, and a column shape.

Further, in the step (a-3) of manufacturing a fine powder by high-energy milling in an atmosphere of atmosphere, vacuum, nitrogen, or argon, by applying a high energy of 0.6 to 2.4 J/g·s, and by rotating the rotating vessel and a rotating shaft in different directions to each other,
wherein the rotating shaft is rotated at 150 to 300 rpm,
wherein the rotating vessel is rotated at 300 to 600 rpm in a direction opposite to the direction of rotation of the rotating shaft, and
wherein the high-energy milling may be performed for 1 to 20 hours.

Here, the high-energy milling process may include supplying energy of 0.6 to 2.4 J/g·s, with the rotating shaft and the rotating vessel rotating in opposite directions, causing friction between the steel balls and the mixed powder of the vanadium oxide and the carbon compound placed in the rotation vessel, thereby milling and crushing the particles of the mixed powder of vanadium oxide and the carbon compound to reduce the average particle size of the mixed powder within the range of 2 nm to 50 μm.

In addition, in the step (a-4) of manufacturing a vanadium carbide containing an oxygen content of 4,000 ppm or less and a carbon content of less than 15 wt % by carbothermic reduction reaction by vacuum heat treatment of the fine powder, wherein in the vacuum heat treatment, the heat treatment temperature may be 800° C. to 1600° C., and the heat treatment time may be from 10 minutes to 24 hours.

Here, when the heat treatment temperature of the vacuum heat treatment is within the above range of 800° C. to 1600° C., the oxygen reduction properties and manufacturing efficiency of the vanadium carbide containing an oxygen content of 4,000 ppm or less and a carbon content of less than 15 wt % may be excellent.

That is, the mixed powder of the vanadium oxide and the carbon compound produced by the high-energy milling device may undergo vacuum heat treatment at the heat treatment temperature of the vacuum heat treatment, enabling manufacture of the vanadium carbide containing an oxygen content of 4,000 ppm or less and a carbon content of less than 15 wt %, exhibiting excellent oxygen reduction characteristics and manufacturing efficiency.

In this case, the heat treatment temperature of the vacuum heat treatment may preferably be from 850° C. to 1600° C.

More preferably, the heat treatment temperature of the vacuum heat treatment may preferably be from 900° C. to 1600° C.

In addition, when the heat treatment time of the vacuum heat treatment is within the above range from 10 minutes to 24 hours, the oxygen reduction properties and manufacturing efficiency of the vanadium carbide containing an oxygen content of 4,000 ppm or less and a carbon content of less than 15 wt % may be excellent.

That is, the mixed powder of the vanadium oxide and the carbon compound produced by a high-energy milling device may undergo vacuum heat treatment for the beat treatment time of the vacuum heat treatment, enabling manufacture of the vanadium carbide containing an oxygen content of 4,000 ppm or less and a carbon content of less than 15 wt %, exhibiting excellent oxygen reduction characteristics and manufacturing efficiency.

In this case, the heat treatment time of the vacuum heat treatment may preferably be from 20 minutes to 24 hours.

More preferably, the heat treatment time of the vacuum heat treatment may preferably be from 30 minutes to 24 hours.

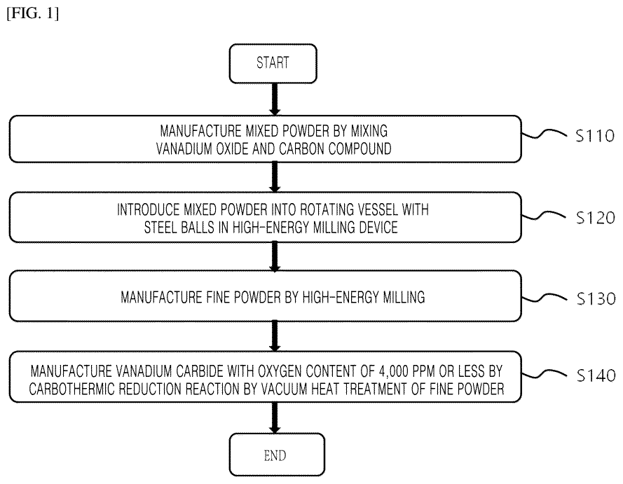

FIG. 1 is a process flow diagram of a method for manufacturing a vanadium carbide containing an oxygen content of 4,000 ppm or less and a carbon content of less than 15 wt % according to an exemplary embodiment of the present disclosure.

Referring to FIG. 1, a mixed powder may be manufactured by mixing vanadium oxide with carbon compound (S110).

Then, the mixed powder may be introduced together with steel balls into a rotating vessel within a high-energy milling device (S120).

Then, a fine powder may be manufactured by high-energy milling in an atmosphere of atmosphere, vacuum, nitrogen, or argon, by applying a high energy of 0.6 to 2.4 J/g·s, and by rotating the rotating vessel and a rotating shaft in different directions to each other (S130).

Afterwards, the fine powder may be subjected to vacuum heat treatment for carbothermic reduction reaction to manufacture a vanadium carbide containing an oxygen content of 4,000 ppm or less and a carbon content of less than 15 wt % (S140).

In the following, exemplary embodiments of the present disclosure will be described in more detail. However, the following exemplary embodiments are intended to further illustrate the present disclosure, and the scope of the present disclosure is not limited by the following exemplary embodiments. The following exemplary embodiments may be modified and altered as appropriate by those skilled in the art within the scope of the present disclosure.

### EXEMPLARY EMBODIMENTS

### <Exemplary Embodiments 1 to 7> Manufacturing a Vanadium Carbide Containing an Oxygen Content of 4,000 ppm or Less and a Carbon Content of Less than 15 wt %

By using the ingredients and contents shown in Table 1 below, the mixed powder of vanadium oxide and carbon compound was prepared.

Then, the mixed powder was introduced with steel balls into a rotating vessel in a high-energy milling device.

Then, the fine powder was prepared by high-energy milling in a high-energy milling device by injecting high-energy as shown in Table 1 below in an atmosphere of atmosphere, vacuum, nitrogen or argon, which are gaseous conditions for particle grinding, and by rotating the rotating shaft and the rotating vessel respectively in different directions to each other.

Afterwards, the fine powder was subjected to the vacuum heat treatment under the conditions of Table 1 below for causing carbothermic reduction reaction to manufacture a vanadium carbide containing an oxygen content of 4,000 ppm or less and a carbon content of less than 15 wt %.

### <Comparative Example> Manufacturing a Vanadium Carbide

The vanadium carbide of the comparative example was prepared in the same manner as in the exemplary embodiment 4, except that a planetary ball mill was used as the high-energy milling device in the exemplary embodiment 4.

TABLE 1

| | Exemplary | Exemplary | Exemplary | Exemplary | Exemplary | Exemplary | Exemplary | Comparative |
|---|---|---|---|---|---|---|---|---|
| | Embodiment 1 | Embodiment 2 | Embodiment 3 | Embodiment 4 | Embodiment 5 | Embodiment 6 | Embodiment 7 | Example |
| vanadium oxide | vanadium | vanadium | vanadium | vanadium | vanadium | vanadium | vanadium | vanadium |
| (A) | pentoxide | pentoxide | pentoxide | pentoxide | pentoxide | pentoxide | pentoxide | pentoxide |
| | (V₂O₅) | (V₂O₅) | (V₂O₅) | (V₂O₅) | (V₂O₅) | (V₂O₅) | (V₂O₅) | (V₂O₅) |
| carbon compound | graphite | graphite | graphite | graphite | graphite | graphite | graphite | graphite |
| (B) | | | | | | | | |
| mole ratio of B/A | 6.30 | 6.40 | 6.50 | 7.00 | 7.05 | 7.10 | 7.15 | 7.00 |
| average particle | 500 nm | 500 nm | 500 nm | 500 nm | 500 nm | 500 nm | 500 nm | 45 μm |
| size of mixed | | | | | | | | |
| powder | | | | | | | | |
| high-energy | planetary | planetary | planetary | planetary | planetary | planetary | planetary | horizontal |
| milling device | ball mill | ball mill | ball mill | ball mill | ball mill | ball mill | ball mill | ball mill |
| energy (J/g · s) | 0.6~2.4 | 0.6~2.4 | 0.6~2.4 | 0.6~2.4 | 0.6~2.4 | 0.6~2.4 | 0.6~2.4 | 0.1~0.2 |
| material of still | cemented | cemented | cemented | cemented | cemented | cemented | cemented | cemented |
| ball | carbide | carbide | carbide | carbide | carbide | carbide | carbide | carbide |
| rotational speed | 250 | 250 | 250 | 250 | 250 | 250 | 250 | 150 |
| (rpm) of rotating | | | | | | | | |
| shaft | | | | | | | | |
| rotational speed | 500 | 500 | 500 | 500 | 500 | 500 | 500 | 150 |
| (rpm) of rotating | | | | | | | | |
| vessel | | | | | | | | |
| atmospheric | atmosphere | atmosphere | atmosphere | atmosphere | atmosphere | atmosphere | atmosphere | atmosphere |
| condition for | | | | | | | | |
| particle milling in | | | | | | | | |
| high-energy | | | | | | | | |
| milling device | | | | | | | | |
| vacuum heat | 1500 | 1500 | 1500 | 1500 | 1500 | 1500 | 1500 | 1500 |
| treatment | | | | | | | | |
| temperature (° C.) | | | | | | | | |
| vacuum heat | 3 hours | 3 hours | 3 hours | 3 hours | 3 hours | 3 hours | 3 hours | 3 hours |
| treatment time | | | | | | | | |
| oxygen content | 3680 | 2260 | 3670 | 3870 | 3370 | 1840 | 1440 | 12000 |
| (ppm) of | | | | | | | | |
| vanadium carbide | | | | | | | | |
| containing | | | | | | | | |
| oxygen content of | | | | | | | | |
| 4,000 ppm or less | | | | | | | | |
| and carbon | | | | | | | | |
| content of less | | | | | | | | |
| than 15 wt % | | | | | | | | |
| chemical formula | x = 0.52 | x = 0.62 | x = 0.64 | x = 0.80 | x = 0.81 | x = 0.86 | x = 0.90 | x = 0.80 |
| (VCx) of | | | | | | | | |
| vanadium carbide | | | | | | | | |
| containing | | | | | | | | |
| oxygen content of | | | | | | | | |
| 4,000 ppm or less | | | | | | | | |
| and carbon | | | | | | | | |
| content of less | | | | | | | | |
| than 15 wt % | | | | | | | | |
| average particle | 500 nm | 500 nm | 500 nm | 500 nm | 500 nm | 500 nm | 500 nm | 10 μm |
| size of vanadium | | | | | | | | |
| carbide | | | | | | | | |
| containing | | | | | | | | |
| oxygen content of | | | | | | | | |
| 4,000 ppm or less | | | | | | | | |
| and carbon | | | | | | | | |
| content of less | | | | | | | | |
| than 15 wt % | | | | | | | | |

Referring to Table 1 above, the oxygen content in the vanadium carbide containing an oxygen content of 4,000 ppm or less and a carbon content of less than 15 wt % according to any one of the exemplary embodiments 1 to 7 was within the range of 1440 ppm to 3870 ppm, which is significantly low in comparison to compared to the oxygen content of 12,000 ppm in the vanadium carbide of the above comparative example.

Thus, it is ascertained that the vanadium carbide containing an oxygen content of 4,000 ppm or less and a carbon content of less than 15 wt % according to any one of the exemplary embodiments 1 to 7 contains less amount of oxygen.

Furthermore, the vanadium carbide containing an oxygen content of 4,000 ppm or less and a carbon content of less than 15 wt % according to any one of the exemplary embodiments 1 to 7 exhibited an average particle size of 500 nm, which is a very small average particle size in comparison to the average particle size of 10 μm of the vanadium carbide of the comparative example.

Thus, it is ascertained that the vanadium carbide containing an oxygen content of 4,000 ppm or less and a carbon content of less than 15 wt % according to any one of the exemplary embodiments 1 to 7 contains less amount of oxygen and has small average particle size, significantly in comparison to the vanadium carbide of the comparative example.

### EXPERIMENTAL EXAMPLES

### <Experimental Example 1> Carbon Content and Oxygen Content in the Vanadium Carbide Containing an Oxygen Content of 4,000 ppm or Less and a Carbon Content of Less than 15 wt %

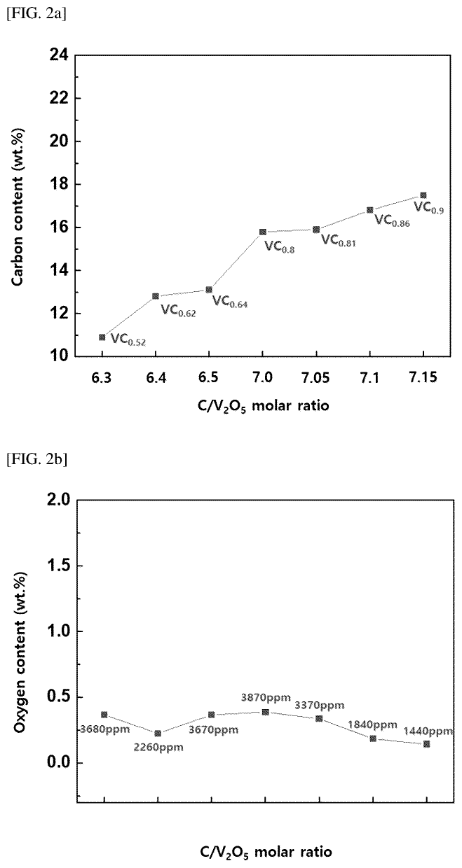

FIGS. 2A and 2B illustrate a carbon content graph and an oxygen content graph of the vanadium carbides containing oxygen content of 4,000 ppm or less and carbon content of less than 15 wt % that are prepared according to the exemplary embodiments 1 to 7.

FIG. 2A is a graph illustrating the carbon content of the vanadium carbides containing oxygen content of 4,000 ppm or less and carbon content of less than 15 wt % according to the exemplary embodiments 1 to 7.

FIG. 2B is a graph illustrating the oxygen content of the vanadium carbides containing oxygen content of 4,000 ppm or less and carbon content of less than 15 wt % according to the exemplary embodiments 1 to 7.

Referring to FIG. 2A, the vanadium carbides containing oxygen content of 4,000 ppm or less and carbon content of less than 15 wt % according to the exemplary embodiments 1 to 7 have the carbon content in the range from 10.5 wt % to 17.5 wt %.

In addition, referring to FIG. 2B, the vanadium carbides containing oxygen content of 4,000 ppm or less and carbon content of less than 15 wt % according to the exemplary embodiments 1 to 7 have the oxygen content in the range from 1440 ppm to 3870 ppm, which is significantly low.

### <Experimental Example 2> Crystal Structure Analysis of the Vanadium Carbide Containing an Oxygen Content of 4,000 ppm or Less and a Carbon Content of Less than 15 Wt %

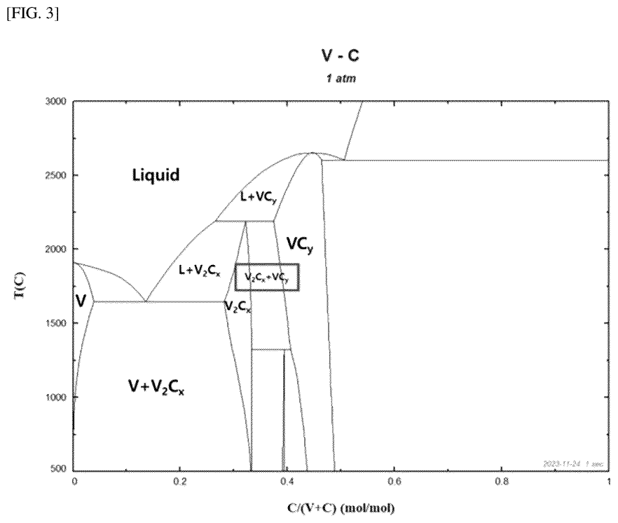

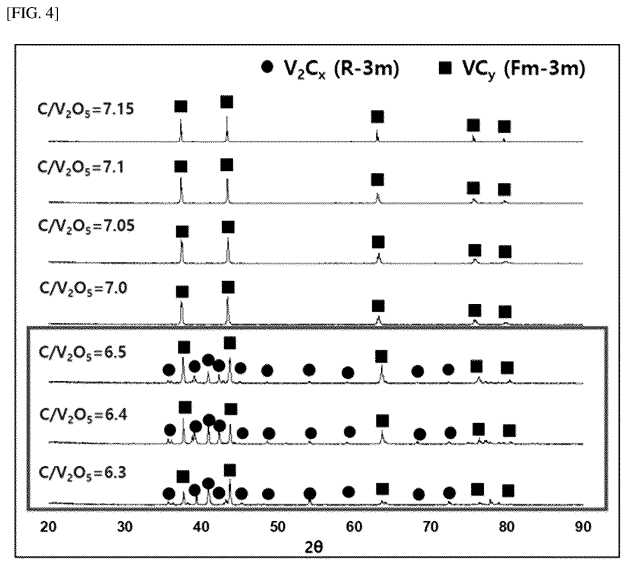

FIGS. 3 and 4 respectively illustrate a phase diagram and an XRD crystal structure of the vanadium carbides containing oxygen content of 4,000 ppm or less and carbon content of less than 15 wt % that are prepared according to the exemplary embodiments 1 to 7.

FIG. 3 is a phase diagram of the vanadium carbides containing oxygen content of 4,000 ppm or less and carbon content of less than 15 wt % that are prepared according to the exemplary embodiments 1 to 7.

As shown in the V-C binary phase diagram in FIG. 3, it is ascertained that the vanadium carbide with an appropriate carbon content is composed of two phases, V₂Cₓ (R-3m) and VC_{y} (Fm-3m).

FIG. 4 is an XRD crystal structure graph of the vanadium carbides containing oxygen content of 4,000 ppm or less and carbon content of less than 15 wt % that are prepared according to the exemplary embodiments 1 to 7.

Referring to FIG. 4, it is ascertained that the exemplary embodiments 1 to 3 are composed of two phases, V₂Cₓ (R-3m) and VC_{y} (Fm-3m).

In the above, exemplary embodiments of the vanadium carbide containing an oxygen content of 4,000 ppm or less and a carbon content of less than 15 wt % according to the present disclosure have been described. Moreover, it will be appreciated that various modifications to these exemplary embodiments are possible without departing from the scope of the present disclosure.

The scope of the present disclosure should therefore not be limited to those exemplary embodiments described above, but should be defined by the following claims and their equivalents.

In other words, the foregoing exemplary embodiments are to be understood as illustrative rather than restrictive in all respects, and the scope of the present disclosure is indicated by the following claims rather than the detailed description. All modifications or variations derived from the meaning, scope, and equivalent concepts of the claims should be interpreted as being included within the scope of the present disclosure.

What is claimed is:

1. A vanadium carbide containing an oxygen content of 4,000 ppm or less and a carbon content of less than 15 wt %,
wherein the vanadium carbide is represented by chemical formula of V₂Cₓ and VC_{y},
wherein a range of the x is 0.5≤x≤0.75,
wherein a range of the y is 0.5≤y≤0.75, and
wherein a crystal system of the vanadium carbide exhibits a combination of a trigonal system (V₂Cₓ) and a cubic system (VC_{y}).

2. The vanadium carbide of claim 1,
wherein the oxygen content of the vanadium carbide is in a range of 10 ppm to 4,000 ppm.

3. The vanadium carbide of claim 1,
wherein the carbon content of the vanadium carbide is in a range from 10.5 wt % to less than 15 wt %.

4. The vanadium carbide of claim 1,
wherein a particle size of the vanadium carbide is in a range of 2 nm to 50 μm.
